(19) United States
(12) Patent Application Publication
(10) Pub. No.: US 2026/0194874 A1
(43) Pub. Date: Jul. 9, 2026

(54) ENHANCED VIRTUALIZED PROTECTION AND CONTROLS SYSTEM FOR ADAPTIVE AND PROTECTIVE POWER GRID CONTROL

(71) Applicant: GE Infrastructure Technology LLC, Greenville, SC (US)

(72) Inventors: Balakrishna PAMULAPARTHY, Hyderabad (IN); Mitalkumar KANABAR, Markham (CA); David MACDONALD, Barcelona (ES); Alejandro LARGACHA FERRERAS, San Sebastián (ES)

(73) Assignee: GE Infrastructure Technology LLC, Greenville, SC (US)

(21) Appl. No.: 19/011,153

(22) Filed: Jan. 6, 2025

(51) Int. Cl. G05B 13/04; G05B 13/02; G06F 9/455

(52) U.S. Cl. CPC G05B 13/048; G05B 13/0265; G06F 9/45558; G06F 2009/4557

(57) ABSTRACT

Devices, systems, and methods for providing virtualized protection and controls (VPAC) for a power grid include virtual machine-based servers corresponding to respective power substations in a power grid and configured to perform virtual protection and other services; a server positioned within a power substation and configured to receive sampled value data for the power grid, wherein at least one of the respective virtual machines is dedicated to processing the sampled value data; protection and controls (PAC) and a zonal autonomous controls (ZAC) for a respective virtual machine; wherein the PAC is configured to determine a real-time intermittency, wherein the ZAC is configured to estimate a forecasted intermittency; and a machine learning model configured to learn first settings to be applied by the PAC adaptively in present time and second settings to be applied by the ZAC proactively in a later time to minimize the difference.

### TECHNICAL FIELD

This disclosure generally relates to power grid management, and more particularly to adaptive and predictive power grid controls.

### BACKGROUND

With the proliferation of inverter-based power generation, such as renewable energy sources, poses challenges for power networks. In particular, faults and load profiles may vary and therefore may be less predictable and more dynamic. There is a need for power network protection to become more dynamic and adaptable.

### SUMMARY

A virtualized protection, automation and controls (VPAC) system for power grids may include processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services; a server positioned within a power substation and configured to receive sampled value data related to the power substation management application, wherein at least one of the respective virtual machine-based servers or software containers is dedicated to processing the sampled value data and to measuring time-synchronized values comprising at least one of root mean square values or phasor values, wherein processing circuitry within a first virtual machine-based server or software container is configured to enable protection, automation and controls (PAC) applications for a respective digital substation; processing circuitry within the first virtual machine-based server or software container or a second virtual machine-based server or software container and configured to enable zonal autonomous control (ZAC) applications locally or remotely for a respective digital substation belonging to a zone; wherein the ZAC applications subscribe to the sampled values and PAC applications-related data from each respective digital substation using routable external communication channels or non-routable internal communication channels, wherein the PAC applications are configured to determine a real-time intermittency in a present interval due to at least one of renewable generation or load dynamics based on the measured time-synchronized values and the sampled value data, wherein the ZAC applications are configured to estimate a forecasted intermittency for a next interval based on the measured time-synchronized values and the sampled value data; and processing circuitry configured as a machine learning model configured to learn, based on a difference between the real-time intermittency and the forecasted intermittency, one or more first PAC applications of the PAC applications and first settings to be applied by the one or more first PAC applications adaptively in the present interval and one or more second PAC applications of the PAC applications and second settings to be applied by the one or more second PAC applications proactively during a next interval to minimize the difference, wherein the PAC applications are configured to apply the one or more first PAC applications and the first settings adaptively based on the real-time operational conditions of the respective power substation, and wherein the ZAC applications are configured to suggest the one or more second PAC applications and the second settings proactively based on optimal forecasted operational conditions of the respective power substation during the next interval.

A method for providing virtualized protection, automation and controls (VPAC) for a power grid may include instantiating processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services; receiving, via a server positioned within a power substation, sampled value data related to the power substation management application, wherein at least one of the respective virtual machine-based servers or software containers is dedicated to processing the sampled value data and to measuring time-synchronized values comprising at least one of root mean square values or phasor values, instantiating processing circuitry within a first virtual machine-based server or software container configured to enable protection, automation and controls (PAC) for a respective digital substation; instantiating processing circuitry within the first virtual machine-based server or software container or a second virtual machine-based server or software container and configured to enable zonal autonomous control (ZAC) applications locally or remotely for a respective digital substation belonging to a zone; subscribing the ZAC applications to the sampled values and PAC applications-related data from each respective digital substation using routable external communication channels or non-routable internal communication channels, determining, by the PAC applications, a real-time intermittency in a present interval due to at least one of renewable generation or load dynamics based on the measured time-synchronized values and the sampled value data, estimating, by the ZAC applications, a forecasted intermittency for a next interval based on the measured time-synchronized values and the sampled value data; and learning, by a machine learning model, based on a difference between the real-time intermittency and the forecasted intermittency, one or more first PAC applications of the PAC applications and first settings to be applied by the one or more first PAC applications adaptively in the present interval and one or more second PAC applications of the PAC applications and second settings to be applied by the PAC applications proactively during a next interval to minimize the difference, applying, by the PAC applications, the one or more first PAC applications and the first settings adaptively based on the real-time operational conditions of the respective power substation, and applying, by the ZAC applications, the one or more second PAC applications and the second settings proactively based on optimal forecasted operational conditions of the respective power substation during the next interval.

A non-transitory computer-readable medium storing instructions that when executed by processing circuitry cause the processing circuitry to: instantiate processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services; receive, via a server positioned within a power substation, sampled value data related to the power substation management application, wherein at least one of the respective virtual machine-based servers or software containers is dedicated to processing the sampled value data and to measuring time-synchronized values comprising at least one of root mean square values or phasor values, instantiate processing circuitry within a first virtual machine-based server or software container configured to enable protection, automation and controls (PAC) for a respective digital substation; instantiating processing circuitry withing the first virtual machine-based server or software container or a second virtual machine-based server or software container and configured to enable zonal autonomous control (ZAC) applications locally or remotely for a respective digital substation belonging to a zone; subscribing the ZAC applications to the sampled values and PAC applications-related data from each respective digital substation using routable external communication channels or non-routable internal communication channels, determine, by the PAC applications, a real-time intermittency in a present interval due to at least one of renewable generation or load dynamics based on the measured time-synchronized values and the sampled value data, estimate, by the ZAC applications, a forecasted intermittency for a next interval based on the measured time-synchronized values and the sampled value data; and learn, by a machine learning model, based on a difference between the real-time intermittency and the forecasted intermittency, one or more first PAC applications of the PAC applications and first settings to be applied by the PAC applications adaptively in the present interval and one or more second PAC applications of the PAC applications and second settings to be applied by the PAC applications proactively during the next time interval to minimize the difference, apply, by the PAC applications, the one or more first PAC applications and the first settings adaptively in the present interval based on real-time operational conditions of the respective power substation, and apply, by the ZAC applications, the one or more second PAC applications and the second settings proactively based on optimal forecasted operational conditions of the respective power substation in the next interval.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for virtualized protection and controls (VPAC) for power grids in accordance with one embodiment of the present disclosure.

FIG. 2 shows an example VPAC system-based zonal autonomous controls (ZAC) plus PAC for adaptive and predictive grid control in accordance with one or more embodiments of the present disclosure.

FIG. 3 shows an example VPAC architecture in accordance with one or more embodiments of the present disclosure.

FIG. 4 shows an example virtual machine with a publisher-subscriber broker arrangement in accordance with one or more embodiments of the present disclosure.

FIG. 5 is an example flow representing a process for providing VPAC for power grids in accordance with one or more embodiments of the present disclosure.

FIG. 6 illustrates an example neural network, in accordance with one or more embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The increase in inverter-based resources (IBRs), such as renewable and variable energy sources, to power networks poses challenges to centralized control and fault protection. It is becoming less practical to set and leave fault protection settings for power networks.

Zonal autonomous control (ZAC) provides techniques for dividing a grid network into autonomous zones and enables intelligent advanced distributed management system (ADMS) solutions. An ADMS provides software for the safe and secure management and orchestration of a power distribution grid. Combining ZAC and ADMS provides distribution optimization, improves network predictability, reduces latency, enables improved use of real-time grid information, improves modeling accuracy, and allows for better system controls.

Virtualization allows for creating services and applications using resources traditionally tied to specific power network hardware. Power grid hardware may be virtualized into intelligent electronic devices (IEDs). Through virtualization, utility infrastructure owners may adopt a gateway and servers to implement them in a redundant system for improved availability. Virtualization may be implemented in both an information technology (IT) domain and an operational technology (OT) domain.

Existing protection and controls (PAC) IEDs based on hardware are not flexible enough to deploy multiple instances of protection algorithms using different configurations of protection settings. PAC IED deployment based on virtual machines (VMs), however, offers improved flexibility to deploy multiple instances of different protection algorithms and of optimization algorithms to learn which protection settings are best for a given substation at different time intervals.

By combining ZAC with virtualized protection, automation, and controls (VPAC), the present disclosure provides significant technical benefits to substation operation, specifically in addressing intermittency of renewable and other variable energy sources. Real-time control of zonal assets may be improved by techniques of the present disclosure for more effective grid management. Zone interruptions may be decreased by techniques of the present disclosure along with individual circuit interruptions within a zone. The volume of data needed for processing may be reduced by techniques of the present disclosure along with necessary bandwidth for providing the data. Integration with renewable and other dynamic energy sources may be improved by techniques of the present disclosure along with responding to weather events. Because control centers may be connected to edge substations, switchyards, and generation facilities, they may be managed with a common set of tools by using techniques of the present disclosure. In addition, installation, maintenance, and upgrading of utility workloads may be simplified and safer by using techniques of the present disclosure.

Using the enhanced VPAC platform herein, PAC and ZAC application versions of a same vendor or different vendors may be run in parallel with different settings per version. A machine learning algorithm may learn which version of PAC, and its corresponding settings, is operating better in a particular scenario or time interval (e.g., an intermittency scenario caused by integration of a renewable energy source), and may apply those settings to a given scenario.

In one or more embodiments, a VPAC system may include VMs, and each VM may host virtual protection relay (VPR) functions with critical and non-critical categories. A VPR may be considered as equivalent to a digital protection relay (e.g., virtualized relay hardware). Critical (RT) and non-critical (non-RT) functions may be isolated at a hypervisor level.

In one or more embodiments, a server located in a substation may receive sampled value (SV) data from merging units (e.g., physical interfaces) with one or more VMs processing SV data in a dedicated manner and measuring time-synchronized root mean squared/phasor values. An SV subscriber within a same server may accept publishers to subscribe to SV measurements via routable (e.g., can travel outside of a substation) or non-routable (e.g., may not travel outside of a substation) communication channels (e.g., using a message queuing telemetry transport broker, a Redis broker, shared memory, ZeroMQ, or the like) in a publisher-subscriber mode.

In one or more embodiments, PAC applications within a same server and a ZAC application within a same or a remote server may subscribe to SV data locally or remotely using a publisher-subscriber broker mechanism, for example. The ZAC application may follow a block-chain-based security mechanism to access and subscribe to SV data remotely, for example.

In one or more embodiments, multiple instances of a PAC application using the same or different strategic protection and control settings may be running in each VM of the server subscribing to SV values locally. Based on forecasting data estimated intermittency, machine learning may be used to suggest PAC predictive controls (e.g., PAC settings) based on the estimated intermittency level. In real-time, the intermittency level may be computed at a local server to deploy previously derived PAC adaptive controls, and the difference between actual and estimated intermittency levels may be computed. The intermittency error (e.g., difference) may be provided to the machine learning for updating/fine-tuning.

In one or more embodiments, the machine learning may learn the PAC adaptive controls versus PAC settings for each VM to evaluate the reduced or zero intermittency level. The machine learning may learn the ZAC predictive controls versus optimizer settings per VM, and PAC settings per VM to evaluate the reduced or zero intermittency level. Based on the control efficacy versus a scenario with reduced or zero intermittency target, the machine learning may learn and facilitate grid orchestration at each substation to smooth renewable energy integration operation and maintain grid inertia and stability.

In one or more embodiments, substation SV data may be published and may be routable or non-routable. The non-routable SV data may be provided to PACs (e.g., 1-N) using settings (e.g., 1-N for VMs 1-N). The routable SV data may be provided to ZACs (e.g., 1-N) with optimizers 1-N (e.g., for VMs 1-N). The ZACs may forecast intermittency, and the PACs may provide real-time intermittency data. The difference between the forecast intermittency and the real-time intermittency may be determined as an intermittency error and provided to a machine learning model. The machine learning model may learn grid orchestration and control efficacy for given scenarios, and may identify optimal protection settings for an upcoming time period (e.g., intermittency level) given the forecasted scenario provided by the ZACs.

For example, a VPAC system may include VMs, and each VM may host VPR functions with critical and non-critical functions isolated at a hypervisor level. A server located in a substation may receive SV data from merging units with one or more VMs processing the SVs and measuring time-synchronized RMS/phasor values. Multiple instances of a PAC application may use different strategic protection and control settings and may be running in each different VM of a server. Multiple instances of a ZAC application may use different strategic optimizer settings and may be running in each different VM of the remote server. Based on the forecasting data estimate intermittency level, PAC predictive controls, including PAC settings, may be suggested based on estimated intermittency level, including +/−X % levels. In real-time, the intermittency level may be computed at the local server to deploy the previously derived PAC adaptive controls, and the difference between actual and estimated intermittency levels may be computed. The intermittency error (e.g., difference) may be provided to the machine learning to update. The machine learning may learn the PAC adaptive controls versus PAC settings per VM to evaluate the reduced or zero intermittency level. The machine learning may learn the ZAC predictive controls versus optimizer settings per VM and PAC settings per VM to evaluate the reduced or zero intermittency level. Based on control efficacy versus scenario with reduced or zero intermittency target, the machine learning may learn and facilitate grid orchestration at each substation (e.g., by selecting protection settings to be implemented at the substation).

The above descriptions are for purposes of illustration and are not meant to be limiting. Numerous other examples, configurations, processes, etc., may exist, some of which are described in greater detail below. Example embodiments will now be described with reference to the accompanying figures.

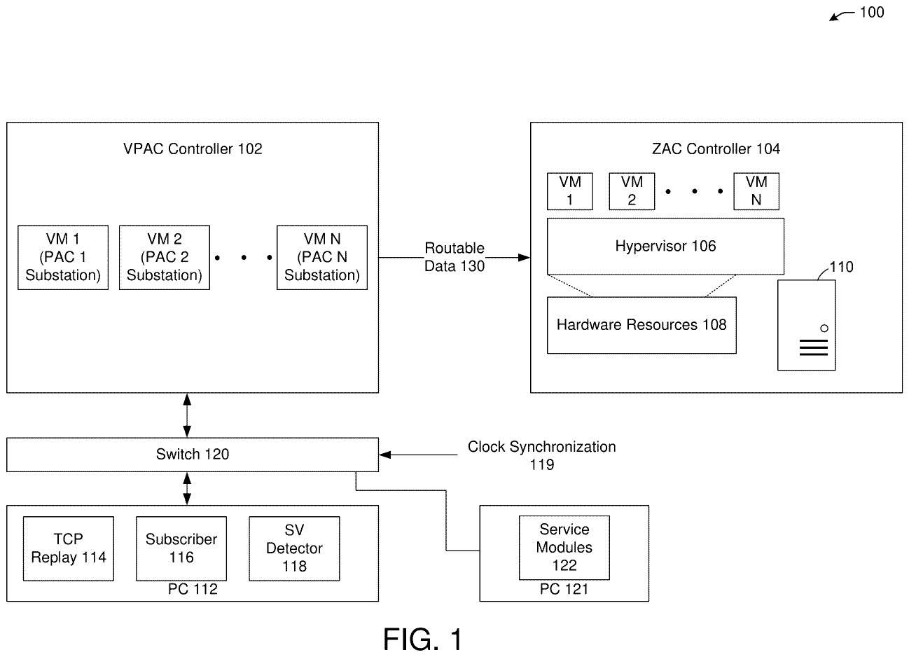

FIG. 1 illustrates an example system 100 for virtualized protection and controls for power grids in accordance with one embodiment of the present disclosure.

Referring to FIG. 1, the system 100 may include a VPAC controller 102 with VMs for PAC substations (e.g., VM 1 for PAC 1 substation, VM 2 for PAC 2 substation,. VM N for PAC N substation). The system 100 also may include a ZAC controller 104 with VMs 1-N. Any of the VPAC controller 102 VMs may use a corresponding ZAC controller such as the ZAC controller 104. Each VM may host VPR functions with critical and non-critical functions isolated at a hypervisor level (e.g., using hypervisor 106). The ZAC controller 104 may include hardware resources 108 (e.g., storage, compute, memory, network, etc.) and a physical server 110. The server 110 (e.g., located in a substation) may receive SV data.

A personal computer (PC) 112 with a TCP replay 114, an SV subscriber 116 (e.g., IEC 61850 GOOSE protocol subscriber), and an SV detector 118 may receive SV data from merging units (e.g., physical interfaces) with one or more VMs (e.g., of the VPAC controller 102) processing SV data in a dedicated manner and measuring time-synchronized (e.g., based on a clock synchronization 119) root mean squared/phasor values. The SV data and the clock synchronization 119 may be provided to a switch 120 (e.g., Ethernet switch) and to the VPAC controller 102. The SV subscriber 116 may accept publishers to subscribe to SV measurements via routable (e.g., can travel outside of a substation) or non-routable (e.g., may not travel outside of a substation) communication channels (e.g., using a message queuing telemetry transport broker, a Redis broker, shared memory, ZeroMQ, or the like) in a publisher-subscriber mode. A PC 121 may provide service modules 122 (e.g., Ansible service modules) to the VPAC controller 102 via the switch 120. In this manner, any SV data may be distributed to multiple protection runtimes (e.g., for different parties), which may be the same or different runtimes (e.g., with different settings groups).

The PC 112 may receive SV data from merging units with one or more VMs of the VPAC controller 102 processing the SVs and measuring time-synchronized RMS/phasor values. Multiple instances of a PAC application may use different strategic protection and control settings and may be running in each different VM of a server. Multiple instances of a ZAC application may use different strategic optimizer settings and may be running in each different VM of the remote server.

In one or more embodiments, multiple instances of a PAC application using the same or different strategic protection and control settings may be running in each VM of the server subscribing to SV values locally. Based on forecasting data estimated intermittency, machine learning may be used to suggest PAC predictive controls (e.g., PAC settings) based on the estimated intermittency level. In real-time, the intermittency level may be computed at a local server to deploy previously derived PAC adaptive controls, and the difference between actual and estimated intermittency levels may be computed. The intermittency error (e.g., difference) may be provided to the machine learning for updating/fine-tuning.

In one or more embodiments, the machine learning may learn the PAC adaptive controls versus PAC settings for each VM to evaluate the reduced or zero intermittency level. The machine learning may learn the ZAC predictive controls versus optimizer settings per VM, and PAC settings per VM to evaluate the reduced or zero intermittency level. Based on the control efficacy versus a scenario with reduced or zero intermittency target, the machine learning may learn and facilitate grid orchestration at each substation to smooth renewable energy integration operation and maintain grid inertia and stability.

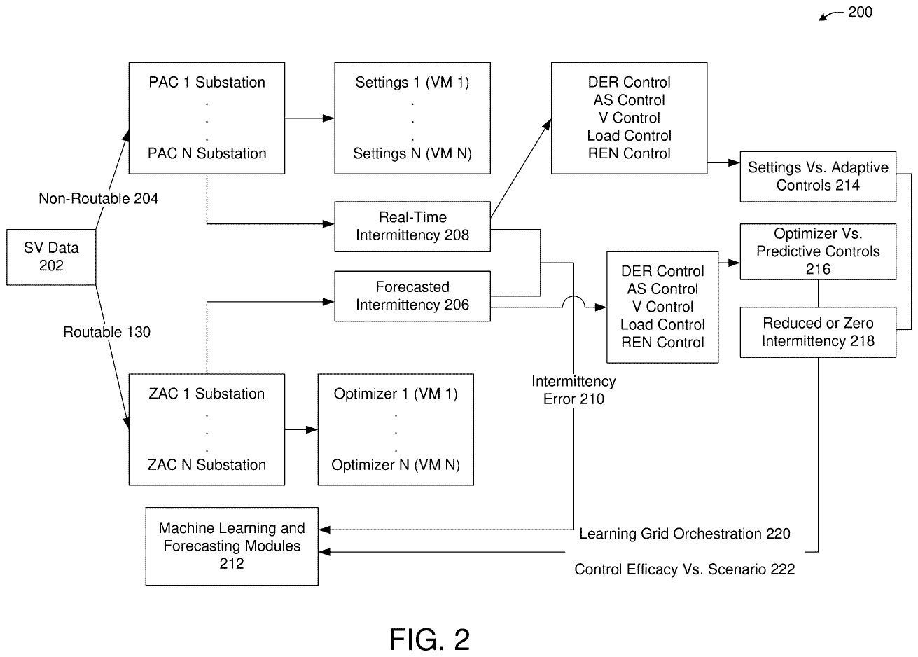

FIG. 2 shows an example VPAC system-based ZAC plus PAC for adaptive and predictive grid control in accordance with one or more embodiments of the present disclosure.

Referring to FIG. 2, SV data 202 may be split into the routable data 130 of FIG. 1 and non-routable data 204. The non-routable data 204 may be provided to PACs (e.g., 1-N) using settings (e.g., 1-N for VMs 1-N). The routable data 130 may be provided to ZACs (e.g., 1-N) with optimizers 1-N (e.g., for VMs 1-N). The ZACs may forecast intermittency 206, and the PACs may provide real-time intermittency data 208. The difference between the forecast intermittency 206 and the real-time intermittency 208 may be determined as an intermittency error 210 and provided to machine learning and forecasting modules 212.

The real-time intermittency 208 and the forecasted intermittency 206 may be used for DER (distributed energy resource) control, automated system (AS) control, voltage (V) control, load control, and renewable energy (REN) control. The real-time intermittency 208 for such controls may be used to compare settings versus adaptive controls 214, and the forecasted intermittency 206 for such controls may be used to compare optimizer versus predictive controls 216. The settings versus adaptive controls 214 and the optimizer versus predictive controls 216 comparisons may be used to identify reduced or zero intermittency 218. The machine learning and forecasting modules 212 may learn grid orchestration 220 and control efficacy 222 for given scenarios, and may identify optimal protection settings for an upcoming time period (e.g., intermittency level) given the forecasted intermittency 206 provided by the ZACs.

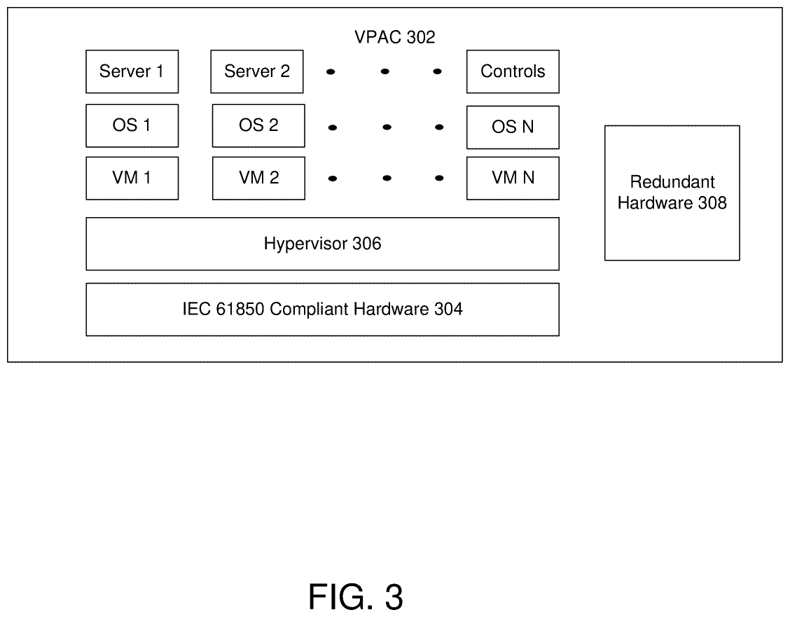

FIG. 3 shows an example VPAC architecture in accordance with one or more embodiments of the present disclosure.

Referring to FIG. 3, a VPAC 302 may include IEC 61850 technical standard compliant hardware 304, a hypervisor 306, and VMs 1-N separated at the hypervisor level. Each VM may have a corresponding operating system (OS) and server/controls (e.g., an engineering server, an authentication server, surveillance and access controls, etc.). The server/controls may have redundant hardware 308 (e.g., engineering server, authentication server, surveillance server, etc.) in the VPAC 302.

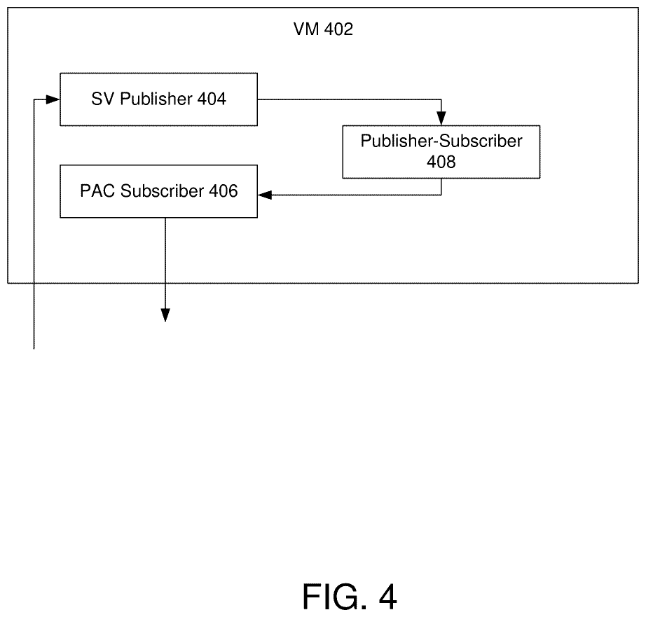

FIG. 4 shows an example VM with a publisher-subscriber broker arrangement in accordance with one or more embodiments of the present disclosure.

Referring to FIG. 4, a VM 402 (e.g., representing any of the VMs of the VPAC 102 of FIG. 1) may include an SV publisher 404, a PAC subscriber 406, and publisher-subscriber 408 modules. The SV publisher 404 may receive frames of SV data and may parse the payloads of the SV data. The result may be processed measurements of the SV data, such as phasors, root mean squared, and the like, which may be provided (e.g., serially) to the publisher-subscriber 408 modules. The PAC subscriber 406 may accept publishers to subscribe to SV measurements via routable (e.g., can travel outside of a substation) or non-routable (e.g., may not travel outside of a substation) communication channels (e.g., using a message queuing telemetry transport broker, a Redis broker, shared memory, ZeroMQ, or the like) in a publisher-subscriber 408 mode.

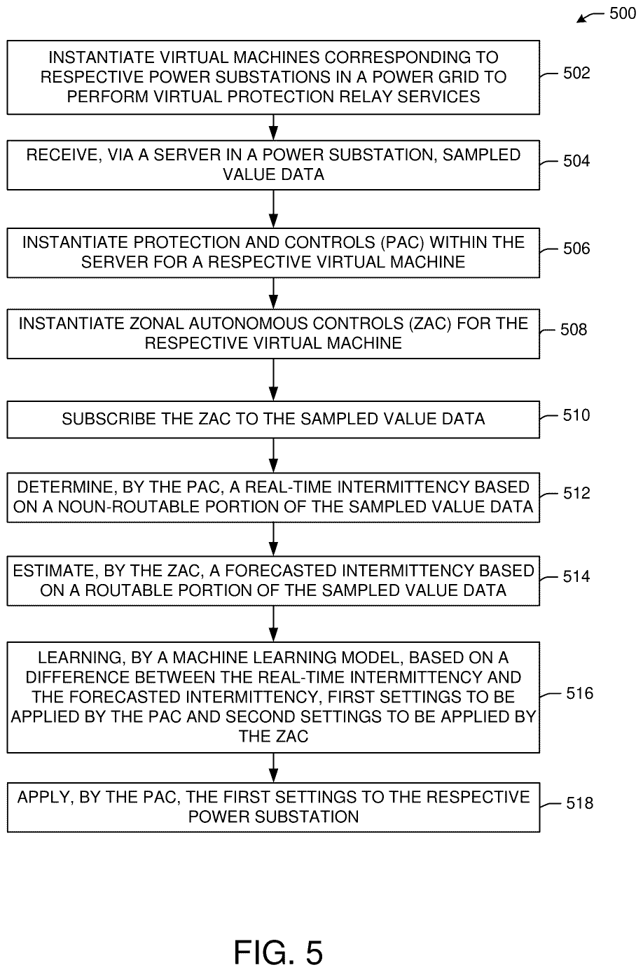

FIG. 5 is a flow of an example process 500 for providing virtualized protection and controls (VPAC) for power grids.

At block 502, a device (or system, the system 100) may instantiate processing circuitry configured as virtual machine-based servers (e.g., VM 1-VM N) or software containers, wherein each respective virtual machine-based server or software container corresponds to a respective power substation management application in a power grid and is configured to perform virtual protection relay (VPR) services separated at a hypervisor level as critical VPR services and non-critical VPR services.

At block 504, the device may receive, via a server positioned within a power substation, sampled value data for the power grid, wherein at least one of the respective virtual machines is dedicated to processing the sampled value data and to measuring time-synchronized values comprising at least one of root mean square values or phasor values.

At block 506, the device may instantiate processing circuitry within the server and configured as protection and controls (PAC) for a respective virtual machine.

At block 508, the device may instantiate processing circuitry configured as a zonal autonomous controls (ZAC) for the respective virtual machine.

At block 510, the device may subscribe the ZAC to the sampled value data using routable external communication channels or non-routable internal communication channels.

At block 512, the device may determine, using the PAC, a real-time intermittency (e.g., for a present time interval) based on a non-routable portion of the sampled value data.

At block 514, the device may estimate (e.g., for a next time interval), using the ZAC, a forecasted intermittency based on a routable portion of the sampled value data.

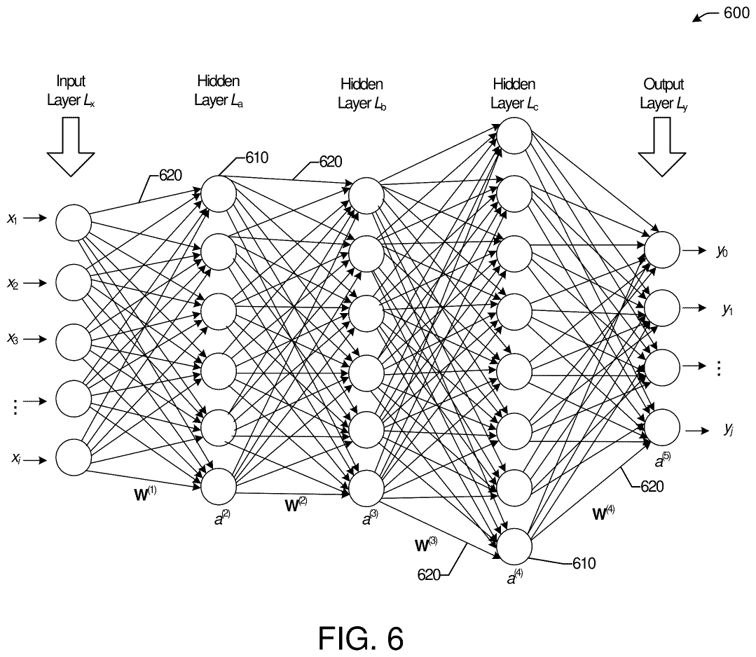

At block 516, the device may learn, via a machine learning model (e.g., the machine learning a forecasting modules 212 of FIG. 2, using the NN 600 of FIG. 6), based on a difference between the real-time intermittency and the forecasted intermittency, first settings to be applied by the PAC and second settings to be applied by the ZAC to minimize the difference.

At block 518, the device may apply, via the PAC, the first settings to the respective PAC applications for the power substation, adaptively during the present interval.

At block 520, the device may apply, via the ZAC, the second settings to the respective ZAC applications for the power substation, proactively for the next time interval.

FIG. 6 illustrates an example neural network 600, in accordance with one or more embodiments.

FIG. 6 illustrates an example neural network (NN) 600, which may be suitable for use by one or more of the computing systems (or subsystems) of the various implementations discussed herein, implemented in part by a HW accelerator, and/or the like. The NN 600 may be deep neural network (DNN) used as an artificial brain of a compute node or network of compute nodes to handle very large and complicated observation spaces. Additionally or alternatively, the NN 600 can be some other type of topology (or combination of topologies), such as a convolution NN (CNN), deep CNN (DCN), recurrent NN (RNN), Long Short Term Memory (LSTM) network, a Deconvolutional NN (DNN), gated recurrent unit (GRU), deep belief NN, a feed forward NN (FFN), a deep FNN (DFF), deep stacking network, Markov chain, perception NN, Bayesian Network (BN) or Bayesian NN (BNN), Dynamic BN (DBN), Linear Dynamical System (LDS), Switching LDS (SLDS), Optical NNs (ONNs), an NN for reinforcement learning (RL) and/or deep RL (DRL), and/or the like. NNs are usually used for supervised learning, but can be used for unsupervised learning and/or reinforcement (RL).

The NN 600 may encompass a variety of ML techniques where a collection of connected artificial neurons 610 that (loosely) model neurons in a biological brain that transmit signals to other neurons/nodes 610. The neurons 610 may also be referred to as nodes 610, processing elements (PEs) 610, or the like. The connections 620 (or edges 620) between the nodes 610 are (loosely) modeled on synapses of a biological brain and convey the signals between nodes 610. Note that not all neurons 610 and edges 620 are labeled in FIG. 6 for the sake of clarity.

Each neuron 610 has one or more inputs and produces an output, which can be sent to one or more other neurons 610 (the inputs and outputs may be referred to as “signals”). Inputs to the neurons 610 of the input layer Lₓ can be feature values of a sample of external data (e.g., input variables xᵢ). The input variables xi can be set as a vector containing relevant data (e.g., observations, ML features, and the like). The inputs to hidden units 610 of the hidden layers Lₐ, L_{b}, and L_{c} may be based on the outputs of other neurons 610. The outputs of the final output neurons 610 of the output layer L_{y} (e.g., output variables yⱼ) include predictions, inferences, and/or accomplish a desired/configured task. The output variables yⱼ may be in the form of determinations, inferences, predictions, and/or assessments. Additionally or alternatively, the output variables yⱼ can be set as a vector containing the relevant data (e.g., determinations, inferences, predictions, assessments, and/or the like).

In the context of ML, an “ML feature” (or simply “feature”) is an individual measurable property or characteristic of a phenomenon being observed. Features are usually represented using numbers/numerals (e.g., integers), strings, variables, ordinals, real-values, categories, and/or the like. Additionally or alternatively, ML features are individual variables, which may be independent variables, based on observable phenomenon that can be quantified and recorded. ML models use one or more features to make predictions or inferences. In some implementations, new features can be derived from old features.

Neurons 610 may have a threshold such that a signal is sent only if the aggregate signal crosses that threshold. A node 610 may include an activation function, which defines the output of that node 610 given an input or set of inputs. Additionally or alternatively, a node 610 may include a propagation function that computes the input to a neuron 1810 from the outputs of its predecessor neurons 610 and their connections 620 as a weighted sum. A bias term can also be added to the result of the propagation function.

The NN 600 also includes connections 620, some of which provide the output of at least one neuron 610 as an input to at least another neuron 610. Each connection 620 may be assigned a weight that represents its relative importance. The weights may also be adjusted as learning proceeds. The weight increases or decreases the strength of the signal at a connection 620.

The neurons 610 can be aggregated or grouped into one or more layers L where different layers L may perform different transformations on their inputs. In FIG. 18, the NN 600 comprises an input layer Lₓ, one or more hidden layers Lₐ, L_{b}, and L_{c}, and an output layer L_{y} (where a, b, c, x, and y may be numbers), where each layer L comprises one or more neurons an10. Signals travel from the first layer (e.g., the input layer L₁), to the last layer (e.g., the output layer L_{y}), possibly after traversing the hidden layers Lₐ, L_{b}, and L_{c}multiple times. In FIG. 6, the input layer La receives data of input variables xᵢ (where i=1, . . . , p, where p is a number). Hidden layers Lₐ, L_{b}, and L_{c} processes the inputs xᵢ, and eventually, output layer L_{y} provides output variables yⱼ (where j=1, . . . , p′, where p′ is a number that is the same or different than p). In the example of Figure an, for simplicity of illustration, there are only three hidden layers Lₐ, L_{b}, and L_{c} in the NN 600, however, the NN 600 may include many more (or fewer) hidden layers Lₐ, L_{b}, and L_{c} than are shown. The term “cloud computing” or “cloud” at least in some examples refers to a

paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “compute resource” or simply “resource” at least in some examples refers to an object with a type, associated data, a set of methods that operate on it, and, if applicable, relationships to other resources. Additionally or alternatively, the term “compute resource” or “resource” at least in some examples refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, and the like), operating systems, virtual machines (VMs), software/applications, computer files, and/or the like. A “hardware resource” at least in some examples refers to compute, storage, and/or network resources provided by physical hardware element(s). A “virtualized resource” at least in some examples refers to compute, storage, and/or network resources provided by virtualization infrastructure to an application, device, system, and the like. The term “network resource” or “communication resource” at least in some examples refers to resources that are accessible by computer devices/systems via a communications network. The term “system resources” at least in some examples refers to any kind of shared entities to provide services, and includes computing and/or network resources. System resources may be considered as a set of coherent functions, network data objects or services, accessible through a server where such system resources reside on a single host or multiple hosts and are clearly identifiable.

The term “cloud service provider” or “CSP” at least in some examples refers to an organization that operates or otherwise provides cloud resources including, for example, centralized, regional, and/or edge data centers and/or the like. In some examples, the term “cloud computing” refers to computing resources and services offered by a CSP.

The term “data center” at least in some examples refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The terms “instantiate,” “instantiation,” and the like at least in some examples refers to the creation of an instance. In some examples, an “instance” also at least in some examples refers to a concrete occurrence of an object, which may occur, for example, during execution of program code.

The term “feature” at least in some examples refers to an individual measurable property, quantifiable property, or characteristic of a phenomenon being observed. Additionally or alternatively, the term “feature” at least in some examples refers to an input variable used in making predictions. At least in some examples, features may be represented using numbers/numerals (e.g., integers), strings, variables, ordinals, real-values, categories, and/or the like.

The term “feature engineering” at least in some examples refers to a process of determining which features might be useful in training an ML model, and then converting raw data into the determined features. Feature engineering is sometimes referred to as “feature extraction.”

The term “feature extraction” at least in some examples refers to a process of dimensionality reduction by which an initial set of raw data is reduced to more manageable groups for processing. Additionally or alternatively, the term “feature extraction” at least in some examples refers to retrieving intermediate feature representations calculated by an unsupervised model or a pretrained model for use in another model as an input. Feature extraction is sometimes used as a synonym of “feature engineering.”

The term “feature map” at least in some examples refers to a function that takes feature vectors (or feature tensors) in one space and transforms them into feature vectors (or feature tensors) in another space. Additionally or alternatively, the term “feature map” at least in some examples refers to a function that maps a data vector (or tensor) to feature space. Additionally or alternatively, the term “feature map” at least in some examples refers to a function that applies the output of one filter applied to a previous layer. In some embodiments, the term “feature map” may also be referred to as an “activation map”.

The term “feature vector” at least in some examples, in the context of ML, refers to a set of features and/or a list of feature values representing an example passed into a model. Additionally or alternatively, the term “feature vector” at least in some examples, in the context of ML, refers to a vector that includes a tuple of one or more features.

The term “forward propagation” or “forward pass” at least in some examples, in the context of ML, refers to the calculation and storage of intermediate variables (including outputs) for a neural network in order from the input layer to the output layer.

The term “hidden layer”, in the context of ML and NNs, at least in some examples refers to an internal layer of neurons in an ANN that is not dedicated to input or output. The term “hidden unit” refers to a neuron in a hidden layer in an ANN.

The term “hyperparameter” at least in some examples refers to characteristics, properties, and/or parameters for an ML process that cannot be learnt during a training process. Hyperparameter are usually set before training takes place, and may be used in processes to help estimate model parameters. Examples of hyperparameters include model size (e.g., in terms of memory space, bytes, number of layers, and the like); training data shuffling (e.g., whether to do so and by how much); number of evaluation instances, iterations, epochs (e.g., a number of iterations or passes over the training data), or episodes; number of passes over training data; regularization; learning rate (e.g., the speed at which the algorithm reaches (converges to) optimal weights); learning rate decay (or weight decay); momentum; number of hidden layers; size of individual hidden layers; weight initialization scheme; dropout and gradient clipping thresholds; the C value and sigma value for SVMs; the k in k-nearest neighbors; number of branches in a decision tree; number of clusters in a clustering algorithm; vector size; word vector size for NLP and NLU; and/or the like.

The term “inference engine” at least in some examples refers to a component of a computing system that applies logical rules to a knowledge base to deduce new information.

The terms “instance-based learning” or “memory-based learning” in the context of ML at least in some examples refers to a family of learning algorithms that, instead of performing explicit generalization, compares new problem instances with instances seen in training, which have been stored in memory. Examples of instance-based algorithms include k-nearest neighbor, and the like), decision tree Algorithms (e.g., Classification And Regression Tree (CART), Iterative Dichotomiser 3(ID 3 ), C4.5, chi-square automatic interaction detection (CHAID), and the like), Fuzzy Decision Tree (FDT), and the like), Support Vector Machines (SVM), Bayesian Algorithms (e.g., Bayesian network (BN), a dynamic BN (DBN), Naive Bayes, and the like), and ensemble algorithms (e.g., Extreme Gradient Boosting, voting ensemble, bootstrap aggregating (“bagging”), Random Forest and the like.

The term “bus” refers to a node to which one or more lines are connected, and which may include loads and/or generators. The term “branch” refers to a connection between respective buses. In this manner, a branch limit is the limit between two buses.

The term “loss function” or “cost function” at least in some examples refers to an event or values of one or more variables onto a real number that represents some “cost” associated with the event. A value calculated by a loss function may be referred to as a “loss” or “error”. Additionally or alternatively, the term “loss function” or “cost function” at least in some examples refers to a function used to determine the error or loss between the output of an algorithm and a target value. Additionally or alternatively, the term “loss function” or “cost function” at least in some examples refers to a function are used in optimization problems with the goal of minimizing a loss or error.

The term “mathematical model” at least in some examples refer to a system of postulates, data, and inferences presented as a mathematical description of an entity or state of affairs including governing equations, assumptions, and constraints. The term “statistical model” at least in some examples refers to a mathematical model that embodies a set of statistical assumptions concerning the generation of sample data and/or similar data from a population; in some examples, a “statistical model” represents a data-generating process.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably.

The term “machine learning algorithm” or “ML algorithm” at least in some examples refers to an application, program, process, algorithm, and/or function that builds or estimates an ML model based on sample data or training data. Additionally or alternatively, the term “machine learning algorithm” or “ML algorithm” at least in some examples refers to a program, process, algorithm, and/or function that learns from experience w.r.t some task(s) and some performance measure(s)/metric(s), and an ML model is an object or data structure created after an ML algorithm is trained with training data. For purposes of the present disclosure, the terms “ML algorithm”, “AI algorithm”, “AI/ML algorithm”, and the like may be used interchangeably. Additionally, although the term “ML algorithm” may refer to different concepts than the term “ML model,” these terms may be used interchangeably for the purposes of the present disclosure.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The term “machine learning entity” or “ML entity” at least in some examples refers to an entity that is either an ML model or contains an ML model and ML model-related metadata that can be managed as a single composite entity (in some examples, metadata may include, for example, the applicable runtime context for the ML model). For purposes of the present disclosure, the term “AI/ML entity” or “ML entity” at least in some examples refers to an entity that is either an AI/ML model and/or contains an AI/ML model and that can be managed as a single composite entity. Additionally, the term “ML entity training” at least in some examples refers to ML model training associated with an ML entity. Moreover, the term “AI/ML” may be used interchangeably with the terms “AI” and “ML” throughout the present disclosure.

The term “AI decision entity”, “machine learning decision entity”, or “ML decision entity” at least in some examples refers to an entity that applies a non-AI and/or non-ML based logic for making decisions that can be managed as a single composite entity.

The term “machine learning training”, “ML training”, or “MLT” at least in some examples refers to capabilities and associated end-to-end (e2e) processes to enable an ML training function to perform ML entity (or ML model) training (e.g., as defined herein). In some examples, ML training capabilities include interaction with other parties/entities to collect and/or format the data required for ML model training. Additionally or alternatively, “training an ML entity” refers to training one or more ML model(s) associated with an ML entity internally by an MLT function.

The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal.

The term “ML initial training” at least in some examples refers to ML entity training that generates an initial version of a trained ML entity.

The term “ML re-training” at least in some examples refers to MLT that generates a new version of a trained ML entity using the same type, but different values or distributions, of training data as that used to train the previous version of the ML entity. This new version of the trained ML entity (e.g., the re-trained ML entity) supports the same type of inference as the previous version of the ML entity, e.g., the data type of inference input and data type of inference output remain unchanged between the two versions of the ML entity

The term “machine learning training function”, “ML training function”, or “MLT function” at least in some examples refers to a (logical) function with MLT capabilities.

The term “AI/ML inference function” or “ML inference function” at least in some examples refers to a (logical) function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

The term “machine learning workflow” or “ML workflow” at least in some examples refers to a process including data collection and preparation, AI/ML model building/generation; ML model training and testing; ML model deployment, ML model execution, ML model validation and/or verification; continuous, periodic and/or asynchronous ML model monitoring; ML model tuning, learning, and/or retraining. In some examples, the ML model monitoring includes self-monitoring or autonomous monitoring). In some examples, the ML model tuning, learning, and/or retraining includes self-tuning (or autonomous tuning), self-learning (or autonomous learning), and/or self-retraining (or autonomous retraining). The term “machine learning lifecycle” or “ML lifecycle” at least in some examples refers to process(es) of planning and/or managing the development, deployment, instantiation, and/or termination of an ML model and/or individual ML model components.

The term “matrix” at least in some examples refers to a rectangular array of numbers, symbols, or expressions, arranged in rows and columns, which may be used to represent an object or a property of such an object.

The terms “model parameter” and/or “parameter” in the context of ML, at least in some examples refer to values, characteristics, and/or properties that are learnt during training. Additionally or alternatively, “model parameter” and/or “parameter” in the context of ML, at least in some examples refer to a configuration variable that is internal to the model and whose value can be estimated from the given data. Model parameters are usually required by a model when making predictions, and their values define the skill of the model on a particular problem. Examples of such model parameters/parameters include weights (e.g., in an ANN); constraints; support vectors in a support vector machine (SVM); coefficients in a linear regression and/or logistic regression; word frequency, sentence length, noun or verb distribution per sentence, the number of specific character n-grams per word, lexical diversity, and the like, for natural language processing (NLP) and/or natural language understanding (NLU); and/or the like.

The terms “regression algorithm” and/or “regression analysis” in the context of ML at least in some examples refers to a set of statistical processes for estimating the relationships between a dependent variable (often referred to as the “outcome variable”) and one or more independent variables (often referred to as “predictors”, “covariates”, or “features”). Examples of regression algorithms/models include logistic regression, linear regression, gradient descent (GD), stochastic GD (SGD), and the like.

The term “reinforcement learning” or “RL” at least in some examples refers to a goal-oriented learning technique based on interaction with an environment. In RL, an agent aims to optimize a long-term objective by interacting with the environment based on a trial and error process. Examples of RL algorithms include Markov decision process, Markov chain, Q-learning, multi-armed bandit learning, temporal difference learning, and deep RL. The term “multi-armed bandit problem”, “K-armed bandit problem”, “N-armed bandit problem”, or “contextual bandit” at least in some examples refers to a problem in which a fixed limited set of resources must be allocated between competing (alternative) choices in a way that maximizes their expected gain, when each choice's properties are only partially known at the time of allocation, and may become better understood as time passes or by allocating resources to the choice. The term “contextual multi-armed bandit problem” or “contextual bandit” at least in some examples refers to a version of multi-armed bandit where, in each iteration, an agent has to choose between arms; before making the choice, the agent sees a d-dimensional feature vector (context vector) associated with a current iteration, the learner uses these context vectors along with the rewards of the arms played in the past to make the choice of the arm to play in the current iteration, and over time the learner's aim is to collect enough information about how the context vectors and rewards relate to each other, so that it can predict the next best arm to play by looking at the feature vectors.

The term “reward function”, in the context of RL, at least in some examples refers to a function that outputs a reward value based on one or more reward variables; the reward value provides feedback for an RL policy so that an RL agent can learn a desirable behavior. The term “reward shaping”, in the context of RL, at least in some examples refers to a adjusting or altering a reward function to output a positive reward for desirable behavior and a negative reward for undesirable behavior.

The term “supervised learning” at least in some examples refers to an ML technique that aims to learn a function or generate an ML model that produces an output given a labeled data set. Supervised learning algorithms build models from a set of data that contains both the inputs and the desired outputs. For example, supervised learning involves learning a function or model that maps an input to an output based on example input-output pairs or some other form of labeled training data including a set of training examples. Each input-output pair includes an input object (e.g., a vector) and a desired output object or value (referred to as a “supervisory signal”). Supervised learning can be grouped into classification algorithms, regression algorithms, and instance-based algorithms.

term “tensor” at least in some examples refers to an object or other data structure represented by an array of components that describe functions relevant to coordinates of a space. Additionally or alternatively, the term “tensor” at least in some examples refers to a generalization of vectors and matrices and/or may be understood to be a multidimensional array. Additionally or alternatively, the term “tensor” at least in some examples refers to an array of numbers arranged on a regular grid with a variable number of axes. At least in some examples, a tensor can be defined as a single point, a collection of isolated points, or a continuum of points in which elements of the tensor are functions of position, and the Tensor forms a “tensor field”. At least in some examples, a vector may be considered as a one dimensional (1D) or first order tensor, and a matrix may be considered as a two dimensional (2D) or second order tensor. Tensor notation may be the same or similar as matrix notation with a capital letter representing the tensor and lowercase letters with subscript integers representing scalar values within the tensor.

The term “tuning” or “tune” at least in some examples refers to a process of adjusting model parameters or hyperparameters of an ML model in order to improve its performance. Additionally or alternatively, the term “tuning” or “tune” at least in some examples refers to a optimizing an ML model's model parameters and/or hyperparameters. In some examples, the particular model parameters and/or hyperparameters that are selected for adjustment, and the optimal values for the model parameters and/or hyperparameters vary depending on various aspects of the ML model, the training data, ML application and/or use cases, and/or other parameters, conditions, or criteria.

The term “unsupervised learning” at least in some examples refers to an ML technique that aims to learn a function to describe a hidden structure from unlabeled data. Unsupervised learning algorithms build models from a set of data that contains only inputs and no desired output labels. Unsupervised learning algorithms are used to find structure in the data, like grouping or clustering of data points. Examples of unsupervised learning are K-means clustering, principal component analysis (PCA), and topic modeling, among many others. The term “semi-supervised learning at least in some examples refers to ML algorithms that develop ML models from incomplete training data, where a portion of the sample input does not include labels.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A virtualized protection, automation and controls (VPAC) system for power grids, the VPAC system comprising:
processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services;
a server positioned within a power substation and configured to receive sampled value data related to the power substation management application, wherein at least one of the respective virtual machine-based servers or software containers is dedicated to processing the sampled value data and to measuring time-synchronized values comprising at least one of root mean square values or phasor values,
wherein processing circuitry within a first virtual machine-based server or software container is configured to enable protection, automation and controls (PAC) applications for a respective digital substation;
processing circuitry within the first virtual machine-based server or software container or a second virtual machine-based server or software container and configured to enable zonal autonomous control (ZAC) applications locally or remotely for a respective digital substation belonging to a zone;
wherein the ZAC applications subscribe to the sampled values and PAC applications-related data from each respective digital substation using routable external communication channels or non-routable internal communication channels,
wherein the PAC applications are configured to determine a real-time intermittency in a present interval due to at least one of renewable generation or load dynamics based on the measured time-synchronized values and the sampled value data,
wherein the ZAC applications are configured to estimate a forecasted intermittency for a next interval based on the measured time-synchronized values and the sampled value data; and
processing circuitry configured as a machine learning model configured to learn, based on a difference between the real-time intermittency and the forecasted intermittency, one or more first PAC applications of the PAC applications and first settings to be applied by the one or more first PAC applications adaptively in the present interval and one or more second PAC applications of the PAC applications and second settings to be applied by the one or more second PAC applications proactively during a next interval to minimize the difference,
wherein the PAC applications are configured to apply the one or more first PAC applications and the first settings adaptively based on the real-time operational conditions of the respective power substation, and
wherein the ZAC applications are configured to suggest the one or more second PAC applications and the second settings proactively based on optimal forecasted operational conditions of the respective power substation during the next interval.

2. The VPAC system of claim 1, wherein a first instance of the PAC applications runs in the respective virtual machine-based server or software container using the first settings, and wherein a second instance of the PAC applications runs in a second virtual machine-based server or software container using PAC settings different than the first settings.

3. The VPAC system of claim 1, wherein a first instance of the ZAC applications runs in a second virtual machine-based server or software container using the second settings, and wherein a second instance of the ZAC applications runs in a third virtual machine-based server or software container using ZAC settings different than the second settings.

4. The VPAC system of claim 1, wherein the machine learning model is further configured to evaluate an intermittency level based on adaptive controls for the PAC applications and settings for the PAC applications, and wherein the first settings are based on the intermittency level.

5. The VPAC system of claim 1, wherein the machine learning model is further configured to evaluate an intermittency level based on predictive controls for the ZAC applications, optimizer settings for the respective virtual machine-based server or software container, and settings for the PAC applications, and wherein the second settings are based on the intermittency level.

6. The VPAC system of claim 1, wherein the PAC applications are further configured to determine a second real-time intermittency based on a non-routable portion of second measured time-synchronized values and second sampled value data for the power grid, wherein the ZAC applications are configured to estimate a second forecasted intermittency based on a routable portion of the second measured time-synchronized values and the second sampled value data; wherein the machine learning model is configured to learn, based on a second difference between the second real-time intermittency and the second forecasted intermittency, third settings to be applied adaptively by the PAC applications in the present interval and fourth settings to be applied by the ZAC applications proactively in the next interval to minimize the second difference, wherein the PAC applications are configured to apply the third settings to the respective power substation adaptively in the present interval, and wherein the ZAC applications are configured to apply the fourth settings to the respective power substation proactively in the next interval.

7. The VPAC system of claim 1, further comprising:
processing circuitry configured as second PAC applications for a second respective virtual machine-based server or software container; and
processing circuitry configured as second ZAC applications for the second respective virtual machine-based server or software container,
wherein the second ZAC applications subscribe to second sampled value data and PAC applications-related data from each respective digital substation for the power grid using second routable external communication channels or second non-routable internal communication channels,
wherein the second PAC applications are configured to determine a second real-time intermittency for the present interval based on second measured time-synchronized values and the second sampled value data,
wherein the second ZAC applications are configured to estimate a second forecasted intermittency for the next interval based on the second measured time-synchronized values and the second sampled value data, and
wherein the machine learning model is further configured to learn, based on a second difference between the second real-time intermittency and the second forecasted intermittency, third settings to be applied by the second PAC applications adaptively in the present interval and fourth settings to be applied by the second PAC applications proactively during next interval to minimize the second difference,
wherein the second PAC applications are configured to apply the third settings adaptively in the present interval based on the real-time conditions of the respective power substation, and
wherein the second ZAC applications are configured to suggest the fourth settings proactively based on the optimal forecasted operational conditions of the respective power substation in the next interval.

8. A method for providing virtualized protection, automation and controls (VPAC) for a power grid, the method comprising:
instantiating processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services;
receiving, via a server positioned within a power substation, sampled value data related to the power substation management application, wherein at least one of the respective virtual machine-based servers or software containers is dedicated to processing the sampled value data and to measuring time-synchronized values comprising at least one of root mean square values or phasor values,
instantiating processing circuitry within a first virtual machine-based server or software container configured to enable protection, automation and controls (PAC) for a respective digital substation;
instantiating processing circuitry within the first virtual machine-based server or software container or a second virtual machine-based server or software container and configured to enable zonal autonomous control (ZAC) applications locally or remotely for a respective digital substation belonging to a zone;
subscribing the ZAC applications to the sampled values and PAC applications-related data from each respective digital substation using routable external communication channels or non-routable internal communication channels,
determining, by the PAC applications, a real-time intermittency in a present interval due to at least one of renewable generation or load dynamics based on the measured time-synchronized values and the sampled value data,
estimating, by the ZAC applications, a forecasted intermittency for a next interval based on the measured time-synchronized values and the sampled value data; and
learning, by a machine learning model, based on a difference between the real-time intermittency and the forecasted intermittency, one or more first PAC applications of the PAC applications and first settings to be applied by the one or more first PAC applications adaptively in the present interval and one or more second PAC applications of the PAC applications and second settings to be applied by the PAC applications proactively during a next interval to minimize the difference,
applying, by the PAC applications, the one or more first PAC applications and the first settings adaptively based on the real-time operational conditions of the respective power substation, and
applying, by the ZAC applications, the one or more second PAC applications and the second settings proactively based on optimal forecasted operational conditions of the respective power substation during the next interval.

9. The method of claim 8, wherein a first instance of the PAC applications runs in the respective virtual machine-based server or software container using the first settings, and wherein a second instance of the PAC applications runs in a second virtual machine-based server or software container using PAC settings different than the first settings.

10. The method of claim 8, wherein a first instance of the ZAC applications runs in a second virtual machine-based server or software container using the second settings, and wherein a second instance of the ZAC applications runs in a third virtual machine-based server or software container using ZAC settings different than the second settings.

11. The method of claim 8, further comprising evaluating, by the machine learning model, an intermittency level based on adaptive controls for the PAC applications and settings for the PAC applications, and wherein the first settings are based on the intermittency level.

12. The method of claim 8, further comprising:
evaluating, by the machine learning model, an intermittency level based on predictive controls for the ZAC applications, optimizer settings for the respective virtual machine-based server or software container, and settings for the PAC applications, and wherein the second settings are based on the intermittency level.

13. The method of claim 8, further comprising:
determining, by the PAC applications, a second real-time intermittency based on a non-routable portion of second measured time-synchronized values and second sampled value data for the power grid;
estimating, by the ZAC applications, a second forecasted intermittency based on a routable portion of the second measured time-synchronized values and the second sampled value data;
learning, by the machine learning model, based on a second difference between the second real-time intermittency and the second forecasted intermittency, third settings to be applied adaptively by the PAC applications in the present interval and fourth settings to be applied by the ZAC applications proactively in the next interval to minimize the second difference;
applying, by the PAC applications, the third settings to the respective power substation adaptively during the present interval; and
applying, by the ZAC applications, the fourth settings to the respective power substation proactively during the next interval.

14. The method of claim 8, further comprising:
instantiating processing circuitry configured as second PAC applications for a second respective virtual machine-based server or software container; and
instantiating processing circuitry configured as a second ZAC applications for the second respective virtual machine-based server or software container,
subscribing the second ZAC applications to second sampled value data and PAC applications-related data from each respective digital substation for the power grid using second routable external communication channels or second non-routable internal communication channels,
determining, by the second PAC applications, a second real-time intermittency for the present interval based on second measured time-synchronized values and the second sampled value data,
estimating, by the second ZAC, a second forecasted intermittency based on a routable portion of the second measured time-synchronized values and the second sampled value data, and
learning, by the machine learning model, based on a second difference between the second real-time intermittency and the second forecasted intermittency, third settings to be applied by the second PAC applications adaptively in the present interval and fourth settings to be applied by the second PAC applications proactively during the next interval to minimize the second difference,
applying, by the second PAC applications, the third settings to the respective power substation adaptively in the present interval; and
applying, by the second ZAC applications, the fourth settings to the respective power substation proactively in the next interval.

15. A non-transitory computer-readable medium storing instructions that when executed by processing circuitry cause the processing circuitry to:
instantiate processing circuitry configured as virtual machine-based servers or software containers, wherein each respective virtual machine-based server or software container corresponds to a respective power substation management application in a power grid and is configured to perform protection, automation, monitoring, control, and optimization services separated at a hypervisor level as critical services and non-critical services;
receive, via a server positioned within a power substation, sampled value data related to the power substation management application, wherein at least one of the respective virtual machine-based servers or software containers is dedicated to processing the sampled value data and to measuring time-synchronized values comprising at least one of root mean square values or phasor values,
instantiate processing circuitry within a first virtual machine-based server or software container configured to enable protection, automation and controls (PAC) for a respective digital substation;
instantiating processing circuitry withing the first virtual machine-based server or software container or a second virtual machine-based server or software container and configured to enable zonal autonomous control (ZAC) applications locally or remotely for a respective digital substation belonging to a zone;
subscribing the ZAC applications to the sampled values and PAC applications-related data from each respective digital substation using routable external communication channels or non-routable internal communication channels,
determine, by the PAC applications, a real-time intermittency in a present interval due to at least one of renewable generation or load dynamics based on the measured time-synchronized values and the sampled value data,
estimate, by the ZAC applications, a forecasted intermittency for a next interval based on the measured time-synchronized values and the sampled value data; and
learn, by a machine learning model, based on a difference between the real-time intermittency and the forecasted intermittency, one or more first PAC applications of the PAC applications and first settings to be applied by the PAC applications adaptively in the present interval and one or more second PAC applications of the PAC applications and second settings to be applied by the PAC applications proactively during the next time interval to minimize the difference,
apply, by the PAC applications, the one or more first PAC applications and the first settings adaptively in the present interval based on real-time operational conditions of the respective power substation, and
apply, by the ZAC applications, the one or more second PAC applications and the second settings proactively based on optimal forecasted operational conditions of the respective power substation in the next interval.

16. The non-transitory computer-readable medium of claim 15, wherein a first instance of the PAC applications runs in the respective virtual machine-based server or software container using the first settings, and wherein a second instance of the PAC applications runs in a second virtual machine-based server or software container using PAC settings different than the first settings.

17. The non-transitory computer-readable medium of claim 15, wherein a first instance of a ZAC applications runs in a first virtual machine-based server or software container using the second settings, and wherein a second instance of the ZAC applications runs in a second virtual machine-based server or software container using ZAC settings different than the second settings.

18. The non-transitory computer-readable medium of claim 15, wherein the machine learning model is further configured to evaluate an intermittency level based on adaptive controls for the PAC applications and settings for the PAC applications, and wherein the first settings are based on the intermittency level.

19. The non-transitory computer-readable medium of claim 15, wherein the machine learning model is further configured to evaluate an intermittency level based on predictive controls for the ZAC applications, optimizer settings for the respective virtual machine-based server or software container, and settings for the PAC applications, and wherein the second settings are based on the intermittency level.

20. The non-transitory computer-readable medium of claim 15, wherein the PAC applications are further configured to determine a second real-time intermittency based on second measured time-synchronized values and second sampled value data for the power grid, wherein the ZAC applications are configured to estimate a second forecasted intermittency based on a routable portion of the second measured time-synchronized values and the second sampled value data; wherein the machine learning model is configured to learn, based on a second difference between the second real-time intermittency and the second forecasted intermittency, third settings to be applied by the PAC applications in the present interval and fourth settings to be applied by the ZAC applications proactively in the next interval to minimize the second difference, wherein the PAC applications are configured to apply the third settings to the respective power substation, and wherein the ZAC applications are configured to apply the fourth settings to the respective power substation.
